(19) United States
(12) Patent Application Publication
(10) Pub. No.: US 2016/0041124 A1
(43) Pub. Date: Feb. 11, 2016

(54) APPARATUS AND METHOD FOR EXTRACTING PARTICLES

(71) Applicant: KNR SYSTEMS INC., Yongin (KR)

(72) Inventor: Myounghan KIM, Yongin (KR)

(21) Appl. No.: 14/822,684

(22) Filed: Aug. 10, 2015

Related U.S. Application Data
(60) Provisional application No. 62/035,517, filed on Aug. 11, 2014.

(51) Int. Cl. G01N 27/447; B01L 3/00; B01L 9/00

(52) U.S. Cl. CPC G01N 27/44791; B01L 9/52; B01L 3/502; B01L 2400/0421; B01L 2200/0631; B01L 2300/06

(57) ABSTRACT

An apparatus and method for extracting particles are provided. The particle extraction apparatus includes: a main body; a support unit provided in the main body and in which a sample plate is disposed; an extraction unit that can be selectively submerged in a sample of the sample plate and that extracts particles within the sample; a signal generator that generates an electrical signal so as to generate an electrical field within the sample within the sample plate; and a controller that controls operation of the signal generator, wherein particles within the sample are attached to the extraction unit to be extracted by an electrical field generated within the sample.

### CROSS-REFERENCE TO RELATED APPLICATION

This application claims the benefit of priority of U.S. Provisional Patent application No. 62/035,517, filed on Aug. 11, 2014, all of which are incorporated by reference in their entirety herein.

### BACKGROUND OF THE INVENTION

1. Field of the Invention

The present invention relates to an apparatus and method for extracting particles, and more particularly, to an apparatus and method for extracting particles using an electrical method.

2. Description of the Related Art

As a method of extracting a target material on a sample, various methods using a chemical or physical method exist. Nowadays, as biotechnology develops, various methods for extracting minute and a small amount of target material like a bio material have been researched and developed, and WO2009/149467 discloses a method of extracting a target material using a probe in a state in which an electrical field is formed in a sample.

### SUMMARY OF THE INVENTION

In the conventional art, a work that extracts a target material on a sample has been performed in a laboratory environment for a long time, but the present invention provides an apparatus and method for extracting particles that can quickly perform an extraction work without a limitation of a location.

The present invention further provides an apparatus and method for extracting particles that extract a target material with an electrical method using a tip and that can improve an extraction rate and that can enhance purity of a target material among an extracted material, compared with the conventional art.

In accordance with an aspect of the present invention, a particle extraction apparatus includes: a main body; a support unit provided in the main body and in which a sample plate is disposed; an extraction unit that can be selectively submerged in a sample of the sample plate and that extracts particles within the sample; a signal generator that generates an electrical signal so as to generate an electrical field within the sample within the sample plate; and a controller that controls operation of the signal generator, wherein particles within the sample are attached to the extraction unit to be extracted by an electrical field generated within the sample.

The signal generator may apply an electrical signal to the sample plate and the extraction unit so as to generate an electrical field within the sample in a state in which the sample plate is disposed at the support unit.

The particle extraction apparatus may further include a holding member in which the extraction unit is installed and that is formed to move the extraction unit upward and downward in an upper portion of the support unit, wherein the extraction unit may be electrically connected to the signal generator in a state installed in the holding member.

The holding member may be formed so that a plurality of extraction units are installed, and the controller may detect a location in which the extraction unit is installed in the holding member and control the signal generator to apply an electrical signal to a corresponding location.

The extraction unit may include a tip member installed in a body and a lower end portion of the body to be submerged in the sample upon extracting particles to form a portion in which particles are extracted. A lower end portion of the tip member may include at least one micro tip, and the micro tip may be formed in a flat shape, and a circumferential edge portion thereof may be formed in a sawteeth shape. The tip member may be produced separately from the body through a thin film manufacturing process including a deposition process and an etching process and may be fixed to a lower end portion of the body.

The tip member may include a connecting portion fixed to the body and a micro tip portion submerged in the sample, and the connecting portion and the micro tip portion may be connected by a separation portion having relatively weak strength in order to easily separate the micro tip portion in a state in which the connecting portion is fixed to the body.

The support unit may be installed to detach the sample plate, and the support unit may include a grip portion that fixes the sample plate when the sample plate is disposed and a signal application unit that applies an electrical signal to the sample plate in a state in which the sample plate is fixed.

The particle extraction apparatus may further include a washing plate for enhancing purity of particles attached to an end portion of the extraction unit, wherein an end portion of the extraction unit to which particles are attached may be controlled to be submerged in a washing liquid of the washing plate so as to wash a foreign substance, when the washing plate is selectively disposed at the support unit.

In accordance with another aspect of the present invention, a method of extracting particles includes: installing a sample plate in which a sample is housed in a support unit; moving the extraction unit downward so that a lower end portion of an extraction unit is submerged in a sample of the sample plate; extracting particles within the sample by applying an electrical signal to the extraction unit and the sample plate; moving upward the extraction unit to which the particles are attached; removing the sample plate from the support unit and installing a washing plate that houses a washing liquid in the support unit; moving the extraction unit downward so as to remove a foreign substance by submerging a lower end portion of the extraction unit in a washing liquid; and moving the extraction unit upward.

In accordance with another aspect of the present invention, an extraction member using in a particle extraction apparatus that extracts particles within a sample by generating an electrical field within the sample includes: a body formed in a bar shape and having one end installed in the particle extraction apparatus; and a tip member attached to the other end portion of the body to form a portion submerged in the sample and having a plurality of micro tips in which protrusions of a sawteeth shape are formed along an edge.

### (Advantages)

According to the present invention, by providing a portable particle extraction apparatus, in various field environments in addition to a laboratory environment, an extraction work can be performed.

By providing an extraction apparatus and method in which an extraction rate is enhanced, compared with the conventional art, a necessary target material can be extracted from a sample including a small amount of sample or target material.

Further, because washing step of an extracted material can be continuously performed, purity of the extracted material can be improved.

### BRIEF DESCRIPTION OF THE DRAWINGS

The objects, features and advantages of the present invention will be more apparent from the following detailed description in conjunction with the accompanying drawings, in which:

FIG. 1 is a perspective view illustrating a particle extraction apparatus according to an exemplary embodiment of the present invention;

FIG. 2 is a block diagram illustrating a major configuration of the particle extraction apparatus of FIG. 1;

FIG. 3 is a perspective view illustrating a sample plate of the particle extraction apparatus of FIG. 1;

FIG. 4 is a cross-sectional view illustrating a support unit of the particle extraction apparatus of FIG. 1;

FIG. 5 is a perspective view illustrating a holding member of the particle extraction apparatus of FIG. 1 separated from a main body;

FIG. 6 is a perspective view illustrating a state in which an extraction process is performed in the particle extraction apparatus of FIG. 1;

FIG. 7 is a perspective view illustrating an extraction unit of the particle extraction apparatus of FIG. 1;

FIG. 8 is a perspective view illustrating a tip member of the extraction unit of FIG. 7;

FIG. 9 is a diagram illustrating an example of a production process of producing the tip member of FIG. 8;

FIG. 10 is a diagram illustrating an extraction process performed by a sample plate and an extraction unit of the particle extraction apparatus of FIG. 1;

FIG. 11 is a front view illustrating an extraction unit assembly provided as consumables;

FIG. 12 is a perspective view illustrating a washing plate of the particle extraction apparatus of FIG. 1; and

FIG. 13 is a flowchart illustrating a method of extracting particles by operating the particle extraction apparatus of FIG. 1.

### DETAILED DESCRIPTION OF EXEMPLARY EMBODIMENTS

Hereinafter, an apparatus and method for extracting particles according to an exemplary embodiment of the present invention will be described in detail with reference to the drawings. In the following description, a location relationship of each element will be described based on the drawing. For convenience of description, the drawing may simplify a structure of the invention or may be exaggeratingly displayed, as needed. However, the present invention is not limited to the following description or an expression on the drawing and various apparatuses may be added, or elements of the present invention may be changed or omitted.

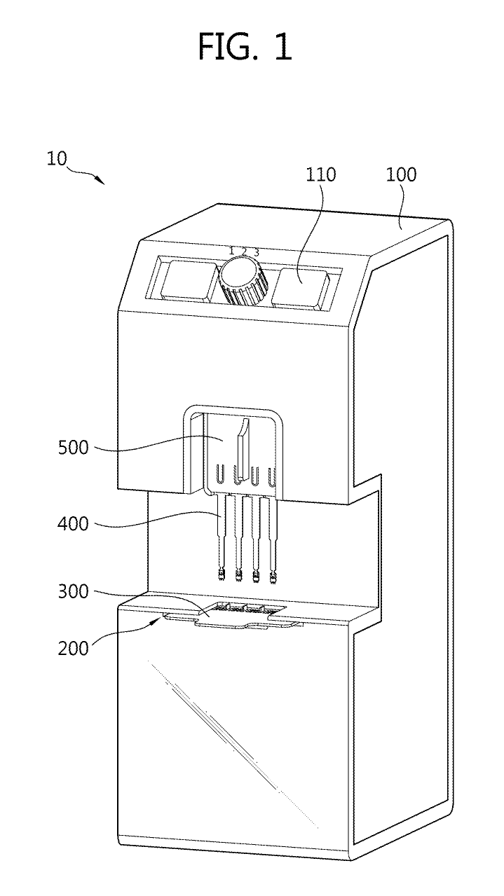

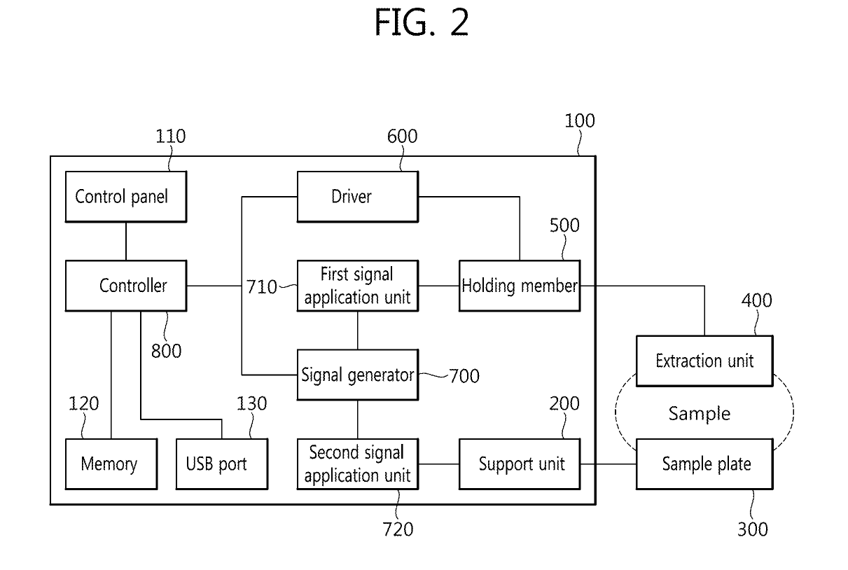

FIG. 1 is a perspective view illustrating a particle extraction apparatus according to an exemplary embodiment of the present invention, and FIG. 2 is a block diagram illustrating a major configuration of the particle extraction apparatus of FIG. 1. A particle extraction apparatus 10 according to the present exemplary embodiment may be an apparatus for extracting deoxyribonucleic acid (DNA) from a sample solution. Extracellular DNA is free DNA released from a cell. Extracellular DNA circulating within a body fluid may be used as an initial identifier of various acute diseases such as a cancer. In such extracellular DNA, as a time consumed for an extraction work is extended, information of DNA is lost. Therefore, a particle extraction apparatus of the present exemplary embodiment is formed to extract DNA through a quick process and to perform an extraction process even in a field environment in addition to a laboratory.

However, in the present exemplary embodiment, extraction of DNA from a body fluid using a particle extraction apparatus has been described as an example, but the present invention is not limited thereto. Further, various target materials such as bacteria, a virus, a cell, and nucleic acid may be extracted using a particle extraction apparatus of the present exemplary embodiment, and various target materials included in a sample in addition to a bio material may be extracted.

A particle may be a material floating on a liquid sample and may be a target material obtained from a sample. As an example, as in the present exemplary embodiment, when extracting DNA from a body fluid, a particle may mean DNA, which is a target material. Further, a particle may be various kinds of target materials to extract, such as bacteria, a virus, a cell, or nucleic acid.

As shown in FIGS. 1 and 2, the particle extraction apparatus 10 according to the present exemplary embodiment includes a main body 100, a support unit 200 in which a sample plate is disposed, an extraction unit 400 that extracts particles corresponding to a target material from a sample, a holding member 500 that holds the extraction unit 400, a driving member 600 for moving the extraction unit 400, a signal generator 700 that generates an electrical signal in order to form an electrical field in a sample, and a controller 800 for controlling operation of the extraction apparatus 10.

The main body 100 is formed with a case and forms an external appearance of the particle extraction apparatus 10. The main body 100 is made of plastic or metal. The main body 100 is used for a table-top platform and is formed in a portable size in which a user may carry. The main body 100 may further have a grip portion (not shown) in which the user may grip upon moving. Therefore, by carrying the particle extraction apparatus 10 to a sample collection site, the user can immediately extract a target material from a sample collected at the site. At an outer surface of the main body 100, a control panel 110 for controlling operation of the particle extraction apparatus 10 is formed. The user may select and perform an extraction process and a washing process through the control panel 110. Further, the user may adjust a time of each process in consideration of a characteristic of a sample or a characteristic of a target material. At the inside of the main body 100, a space that installs various elements such as the controller 800, the driving member 600, and the signal generator 700 is formed.

A sample plate 300 is disposed at the support unit 200 of the particle extraction apparatus 10 and houses a sample to be an extraction target. The support unit 200 forms a space in which the sample plate 300 and a washing plate 350 to be described later are disposed and fixes a location of each plate. As shown in FIG. 1, the support unit 200 includes an inserting port 210 of a slit form at a front surface of the main body 100. The sample plate 300 and the washing plate 350 are slid in the inserting port 210 of the support unit 200 to be fixed. However, a configuration of such a support unit 200 is an example and may be formed in various structures.

The extraction unit 400 is an element that extracts particles from a sample and is disposed at an upper portion of the support unit 200. The extraction unit 400 is held in the holding member 500 of the main body 100 and is installed to move in a vertical direction. Therefore, while an extraction process is performed, the extraction unit 400 moves downward, and a lower end portion of the extraction unit 400 maintains a state submerged in a sample of the sample plate 300. When an extraction process is terminated, the extraction unit 400 moves upward and a lower end portion of the extraction unit 400 deviates from a sample to be located at an upper portion of the sample plate 300.

The driving member 600 provides power that moves the extraction unit 400. The driving member 600 of the present exemplary embodiment makes the extraction unit 400 move upwardly and downwardly by moving the holding member 500 holding the extraction unit 400 upwardly and downwardly. Such a driving member may be formed with various elements such as an actuator, a linear motor, and a linear solenoid. However, FIG. 2 illustrates a configuration in which the driving member 600 directly moves the holding member 500, but the present invention is not limited thereto. In addition, like a lift to be described later, it may be formed to moves a holding member upwardly and downwardly through a separate element, in a state in which a driving member is provided within a holding member and in which the holding member is fixed to a main body, only an extraction unit may be moved.

The signal generator 700 is an element that generates an electric signal, and while an extraction process is performed, the signal generator 700 forms an electrical field in a sample loaded in the sample plate 300. The signal generator 700 may generate an AC signal or a DC signal, and the signal generator 700 of the present exemplary embodiment generates an AC signal. The signal generator 700 is electrically connected to each of the extraction unit 400 and the sample plate 300. Therefore, for an extraction process, the extraction unit 400 and the sample plate 300 each form an electrode to generate an electrical field in a sample.

Specifically, the signal generator 700 includes a first signal application unit 710 and a second signal application unit 720, thereby applying an electrical signal of different phases. The first signal application unit 710 is electrically connected to the holding member 500 and applies an electrical signal to the extraction unit 400 through a conductive path provided in the holding member 500. In this case, even while the holding member 500 lifts by operation of the driving member 600, the holding member 500 maintain a state electrically connected to the signal generator 700, or only in a state in which the holding member 500 is moved downward, the holding member 500 may be electrically connected to the signal generator 700. In a state in which the sample plate 300 is disposed at the support unit 200, the second signal application unit 720 applies an electrical signal to the sample plate 300. Specifically, as the second signal application unit 720 is installed at a location adjacent to the support unit 200, when the sample plate 300 is installed in the support unit 200, the second signal application unit 720 may be electrically connected to the sample plate 300. Alternatively, the second signal application unit 720 may be electrically connected to the sample plate 300 via the support unit 200.

An operation content of the particle extraction apparatus 10 may be set by a content input by the user through the control panel 110. Alternatively, an operation content of the particle extraction apparatus 10 may be set by a program stored at an internal memory 120 or a program input from the outside through an USB port 130 provided in the main body 100. By controlling various elements based on a preset operation content, the controller 800 may drive the particle extraction apparatus 10 with various modes.

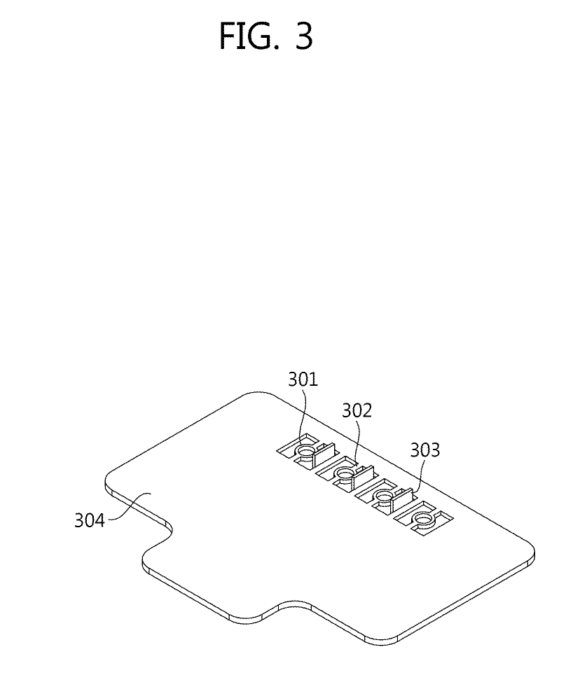

Hereinafter, a configuration of the foregoing sample plate 300, support unit 200, holding member 500, and extraction unit 400 will be described in detail with reference to FIGS. 3 to 11.

FIG. 3 is a perspective view illustrating a sample plate of the particle extraction apparatus of FIG. 1. As shown in FIG. 3, at one side of the sample plate 300, a plurality of sample wells 301 that house a sample are disposed. Each sample well 301 may be formed in a shape having a diameter of 5 mm or less and a thickness of 0.2 to 2 mm. Each sample well 301 has a recess portion (may be a hemisphere shape) having a capacity of 1-50 uL therein. A sample housed in such a sample well 301 may form a hemispherical structure protruded upward by a surface tension. In order to prevent a sample from being overflown or flooded, each sample well 301 has a form isolated from adjacent other portions. Therefore, a plurality of sample wells are formed to minimize a structure connected to an adjacent portion. As an example, a plurality of sample wells 301 of the present exemplary embodiment are disposed at an opened area of the sample plate 300 and are fixed by a thin wire 302 of 1 mm or less. In order to prevent pollution from occurring between samples housed in the sample well 301, a separation wall 303 is formed between a plurality of sample wells 301. Both sides of the sample plate 300 form an insertion portion 304 inserted into the support unit 200. The insertion portion 304 is provided at both sides of a plurality of sample wells and is formed in a shape corresponding to the inserting portion 304 of the support unit 200. The insertion portion 304 of the present exemplary embodiment has a flat structure at both sides, but this is an example and a structure of the insertion portion 304 may be changed according to a fixing structure of the support unit 200 and a shape of the insertion portion 304.

The sample plate 300 includes a conductive material. As an example, the sample plate 300 may be made of a metal material or may be made of a plastic material in which a metal is coated. Therefore, in an extraction process, the sample plate 300 is electrically connected to the second signal application unit 720 to form a second electrode. Such a sample plate 300 may be produced using various production processes such as a press processing, wire cutting, or lithography etching. However, a structure of a sample plate described in the foregoing description is an example and may be changed to various structures.

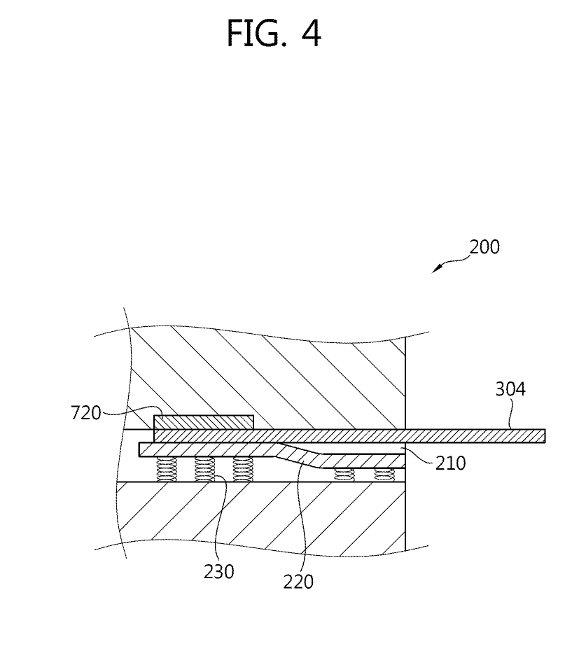

FIG. 4 is a cross-sectional view illustrating both edge portions of a support unit of the particle extraction apparatus of FIG. 1. As shown in FIG. 4, the insertion portion 304 of the sample plate 300 is inserted into and fixed to the inserting port 210 of the support unit 200. The support unit 200 includes a grip portion 220 for fixing the sample plate 300 when the sample plate 300 is inserted and an elastic body 230 that provides an elastic force when the grip portion 220 is fixed. In this case, as the sample plate 300 is inserted into an inserting port, the elastic body 230 is elastically deformed downward and thus an elastic force is applied in a grip portion direction. The grip portion 220 presses the sample plate 300 upward by an elastic force of the elastic body 230 to fix the sample plate 300.

The second signal application unit 720 is provided at a location adjacent to the inside of the support unit 200. Therefore, when the sample plate 300 is pressed by the grip portion 220 to be fixed, the second signal application unit 720 and the sample plate 300 are electrically connected.

A cross-section structure of the support unit 200 of FIG. 4 is provided at each of both ends of the support unit 200 to fix both sides of the sample plate 300. However, a grip portion may be provided in a center direction of a support unit to fix the center of the sample plate.

In the foregoing description, a configuration of the support unit 200 has been described with reference to FIG. 4, but the present invention is not limited thereto and the support unit 200 may be formed with various methods. For example, the support unit 200 may be formed in a stage form and may fix a sample plate using a clamp and a guide member. However, when it is differently designed, in a state in which a sample plate is disposed, the sample plate and a signal generator may be electrically connected.

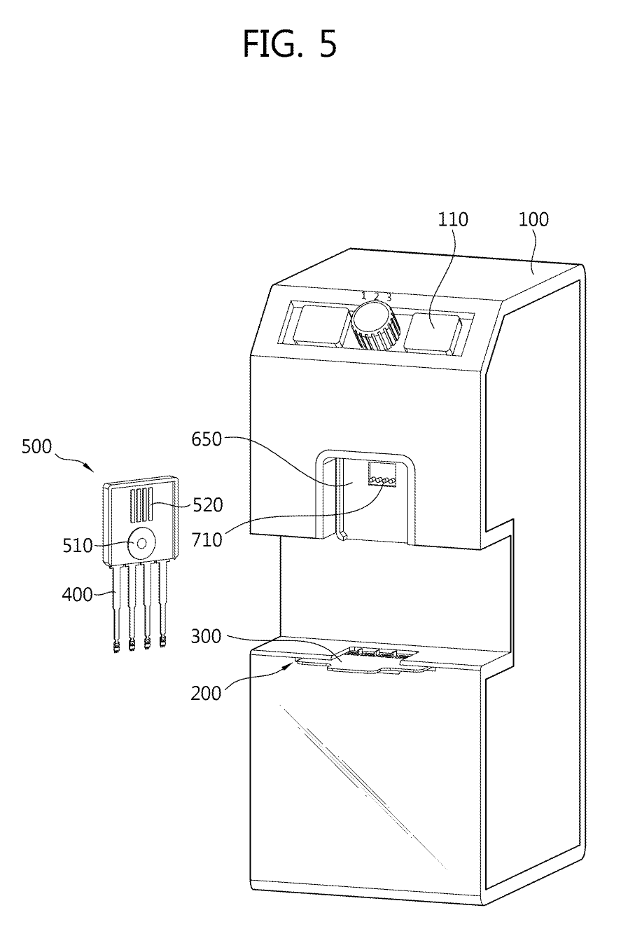

FIG. 5 is a perspective view illustrating a holding member of the particle extraction apparatus of FIG. 1 separated from a main body. As described above, the holding member 500 holds a plurality of extraction units 400. As shown in FIG. 5, the holding member 500 of the present exemplary embodiment has a plurality of inserting ports (not shown) in which a plurality of extraction units 400 are each inserted in a lower portion. Therefore, an upper end portion of the extraction unit 400 is inserted into the inserting port to be fixed to the holding member 500. Here, the extraction unit 400 is detachably installed in the holding member 500. Therefore, an extraction unit already used in an extraction process may be replaced with a new extraction unit. A method of fixing the extraction unit may be variously performed using mechanical springs or other holding mechanism.

The holding member 500 is detachably installed in a lifting member 650 provided at one side of the main body 100. As an example, the holding member 500 or the lifting member 650 includes a magnetic body 510, and the holding member 500 may be magnetically detachably installed in the lifting member 650. In this case, a work that installs or replaces the extraction unit 400 in the holding member 500 may be easily performed.

The lifting member 650 is installed to be moved upwardly and downwardly by the driving member 600 of the main body 100. As shown in FIG. 5, the lifting member 650 has a U-shaped guide member 651, and the holding member 500 is installed at the inside of the guide member. While the lifting member 650 is moved by driving of the driving member 600, the holding member 500 and the extraction unit 400 installed in the holding member 500 are also moved.

As described above, the holding member 500 is electrically connected to the first signal application unit 710 to transfer an electrical signal to the extraction unit 400. The first signal application unit 710 is disposed at a location adjacent to the lifting member 650, and at a rear surface of the holding member 500, a conductive connector 520 that contacts with the first signal application unit 710 to be electrically connected is provided. In this case, even while the holding member 500 moves, in order to maintain an electrical connection state, the conductive connector 520 is formed in a form extended in a vertical direction. However, this is an example and only in a state in which a holding member is moved downward to a location in which an extraction process is performed, the holding member may be electrically connected to the first signal application unit.

The number of the first signal application unit 710 and the conductive connector 520 corresponds to that of the extraction unit 400 that can be installed in the holding member 500. The holding member 500 has each path that transfers an electrical signal to a plurality of extraction units 400. Therefore, each extraction unit 400 may receive different electrical signals by the control of the controller 800 to perform different extraction processes.

Further, the controller 800 may detect a location of the extraction unit 400 installed in the holding member 500. Therefore, even if the extraction unit 400 is installed only in some of a plurality of inserting ports, the controller 800 may control to transfer an electrical signal to a location in which the extraction unit 400 is installed.

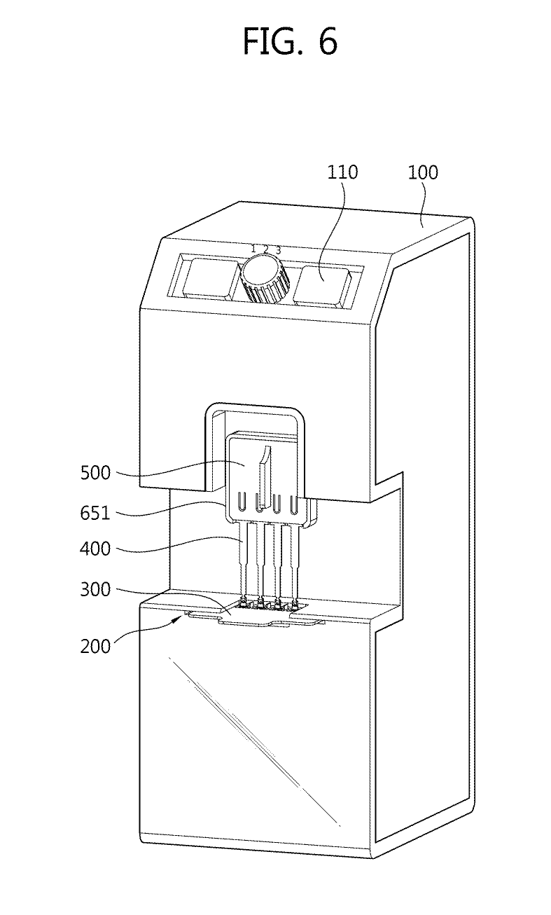

FIG. 6 is a perspective view illustrating a state in which an extraction process is performed in the particle extraction apparatus of FIG. 1. As shown in FIG. 6, the sample plate 300 is disposed at the support unit 200. In a state fixed to the holding member 500, a plurality of extraction units 400 are installed in the lifting member 650 of the main body 100, and the lifting member 650 moves downward according to driving of the driving member 600. In this case, a location of a plurality of extraction units 400 corresponds to that of a plurality of sample wells 301 of the sample plate 300. Therefore, in a state in which the extraction unit 400 is moved downward, an end portion of the extraction unit 400 is submerged in a sample of the sample plate 300, and in this state, an extraction process is performed.

In this case, in an entire sample well in which the extraction unit 400 is installed, an extraction process may be simultaneously performed, an extraction process may be performed only in some sample wells by the control of the controller 800. Further, even in a state in which the extraction unit 400 is installed only in some of inserting ports of the holding member 500, an extraction process may be performed.

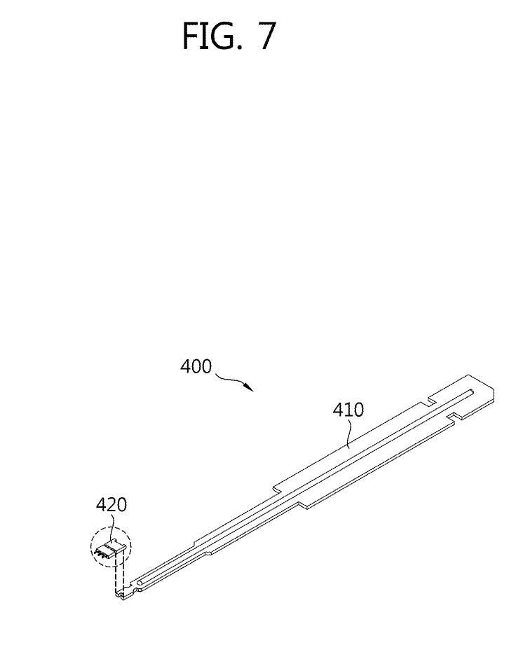

FIG. 7 is a perspective view illustrating an extraction unit of the particle extraction apparatus of FIG. 1. As shown in FIG. 7, the extraction unit 400 includes a body 410 and a tip member 420 installed in a lower end portion of the body 410. Because the tip member 420 of the present exemplary embodiment is formed in a relatively micro structure, compared with the body 410, it may be inefficient to produce the tip member 420 by one process. Therefore, in the present exemplary embodiment, after the body 410 and the tip member 420 are each produced through a separate process, by attaching/installing the tip member 420 to/in a lower end portion of the body 410, the extraction unit 400 is formed. However, this is an example and an extraction unit may be produced by one process.

First, the body 410 is formed in a prong shape extended in a lengthwise direction. The body 410 includes a conductive material such as a metal or plastic in which a metal is coated. An upper end portion of the body 410 is inserted into an inserting port of the holding member 500 to be held. Therefore, in order to be held by a holding mechanism of the holding member 500, the upper end portion of the body 410 has a structure including a groove. A lower end portion of the body 410 is a portion in which the tip member 420 is installed and is formed to easily install the tip member 420. As an example, in the present exemplary embodiment, the tip member 420 is installed by soldering in a lower end portion of the body 410, and the lower end portion of the body 410 may be formed in a fork shape advantageous to attachment by soldering.

The tip member 420 forms a lower end portion of the extraction unit 400 and is a portion in which particles of the sample are attached to be extracted in a state submerged in the sample in an extraction process. Therefore, such a tip member 420 includes at least one micro tip 451 and includes a conductive material so as to form a first electrode within a sample.

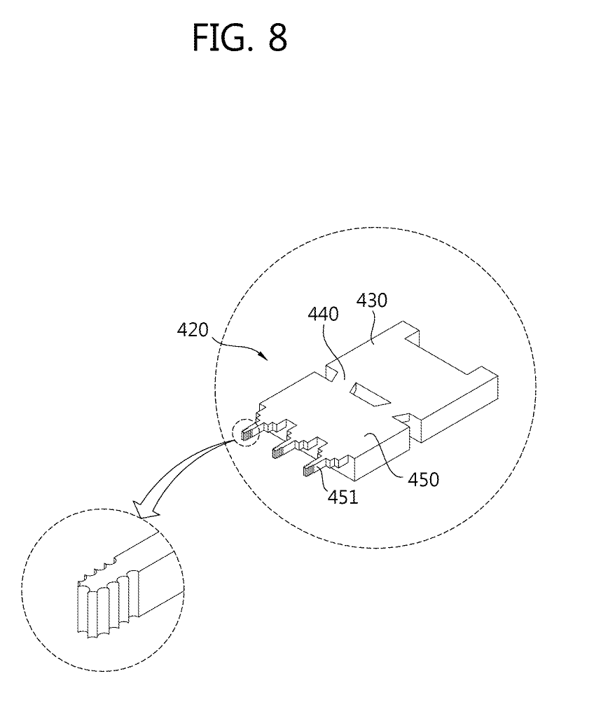

FIG. 8 is a perspective view illustrating a tip member of the extraction unit of FIG. 7. Hereinafter, a structure of the tip member 420 will be described in detail with reference to FIG. 8. As shown in FIG. 8, the tip member 420 includes a connecting portion 430, a micro tip portion 450, and a separation portion 440.

Here, the connecting portion 430 forms one side of the tip member 420 and is a portion coupled to a lower end portion of the body 410. As described above, the connecting portion 430 is installed in a lower end portion of the body 410 by soldering. The micro tip portion 450 is provided in a lower end portion of the connecting portion 430 and includes at least one micro tip 451 of a micro scale or a nano scale. Such a micro tip 451 is submerged within a sample in an extraction process and forms a portion in which particles are attached. Such a connecting portion 430 and micro tip portion 450 are connected by a separation portion. The separation portion 440 is formed in an easy fracture structure to easily separate the micro tip portion 450 from the connecting portion 430. Therefore, after an extraction process is terminated, in a state fixed to the body 410 of the extraction unit 400, the connecting portion 430 of the tip member 420 may perform a test by easily separating only the micro tip portion 450 in which particles are attached. As shown in FIG. 8, the separation portion 440 is formed in a V-type groove form having a cross-sectional area (narrow width and thin thickness) smaller than that of the adjacent connecting portion 430 and micro tip portion 450 and may be formed in various structures.

The micro tip portion 450 of the present exemplary embodiment includes three micro tips 451 protruded in a cantilever structure. Each micro tip 451 is formed in a pointed shape having a width of 500 um or less and may have a structure having a sequentially reducing width in a protrusion direction. In this case, in order to have a more pointed shape, the micro tip 451 may have a thickness smaller than that of an adjacent portion (e.g., other portions of a micro tip portion).

The micro tip 451 according to the present exemplary embodiment has a structure in which pointed protrusions of 100 um or less are formed along an edge portion. When particles move in a micro tip direction by an electrical field within the sample, a particle extraction apparatus according to the present exemplary embodiment uses a method in which particles are attached to a micro tip to be extracted. As an experimental result, unlike a micro tip having a smooth edge, when using a micro tip in which pointed protrusions are formed along an edge, it was determined that an extraction rate of particles is improved. Therefore, in the present exemplary embodiment, as shown in FIG. 8, by forming an edge of the micro tip 451 in a sawteeth shape, an extraction rate is improved.

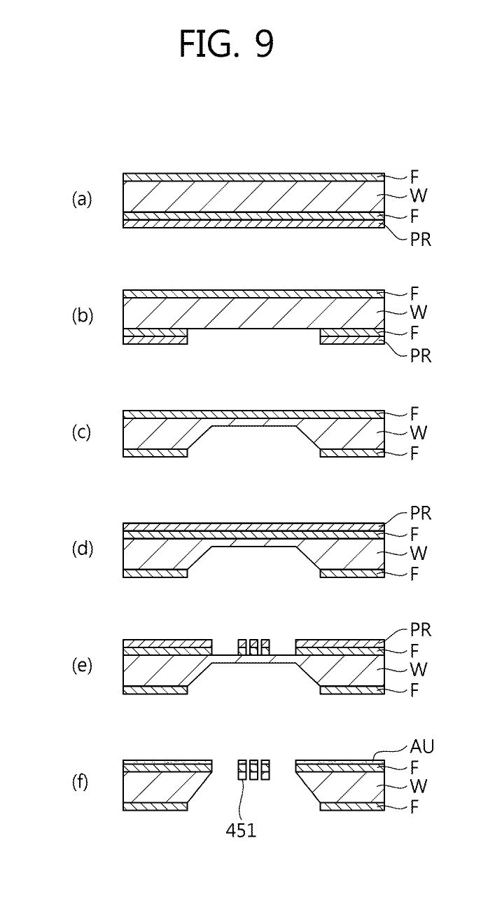

As described above, such a tip member 420 has a more micro structure than that of the body 410. Therefore, the body 410 is produced by a mechanical processing such as press and cutting, whereas the tip member 420 may be separately produced through a thin film manufacturing process such as deposition and etching. Hereinafter, a production method of a tip member will be described in detail with reference to FIG. 9.

FIG. 9 is a diagram illustrating an example of a production process of producing the tip member of FIG. 8. A cross-section of FIG. 9 is shown in an end portion direction of a micro tip of a tip member. A micro tip portion having a relatively narrow width and thin thickness and having a sawteeth shape along an edge is produced through the following process.

First, step of processing a rear surface of the tip member 420 is performed. At a rear surface of a silicon wafer substrate W in which a film F is attached to both surfaces, photoresist (PR) is coated (FIG. 9A). By selectively exposing the PR using a mask (not shown) in which a pattern is formed, a pattern is formed (FIG. 9B). A rear surface of the substrate W is etched using etchant such as potassium hydroxide (FIG. 9C). In this case, a thickness of a micro tip portion is determined according to a depth in which the rear surface of the substrate W is etched.

When a processing of a rear surface of the tip member 420 is terminated, step of processing a front surface of the tip member 420 is performed. At a front surface of the substrate W, the PR is coated (FIG. 9D), and by exposing using a mask (not shown) in which a pattern is formed, a pattern is formed (FIG. 9E). In this case, the formed pattern is formed to correspond to a shape of a plurality of micro tips and a shape of sawteeth formed along an edge of a tip. By performing etching by such a pattern, after the micro tip 451 is formed, deposition may be performed with a method of depositing a conductive material such as Au (FIG. 9F). In this case, in the micro tip, conductive polymer for enhancing a binding characteristic of particles may be deposited.

In this way, in the present exemplary embodiment, a micro tip is produced using a thin film manufacturing process used in a semiconductor process. Here, the tip member 420 and the micro tip 451 are formed in a flat shape, but in the micro tip 451, because rear surface etching is performed further than that in the remaining portions of the tip member 420, the micro tip 451 has a relatively small thickness. Therefore, a front surface of the micro tip 451 is formed co-planar to a front surface of the remaining tip member 420, and a rear surface of the micro tip 451 has a structure that forms a step from a rear surface of the remaining tip member 420.

In the foregoing description, production of the micro tip 451 has been described, the separation portion 440 having a V-type groove form as well as the micro tip 451 may be simultaneously produced through the process. In this case, similar to the micro tip 451, in a portion corresponding to the separation portion 440, rear surface etching is performed, and upon processing a front surface, light exposure and etching may be performed to have a pattern corresponding to a V-type groove.

The tip member 420 produced with such a method is attached to a lower end portion of the body 410 by soldering to form the extraction unit 400. As described above, because both the body 410 and the tip member 420 may be made of a metal or a conductive material coated by a metal, in an extraction process, an electric signal is transferred from the signal generator 700 to form an electrode.

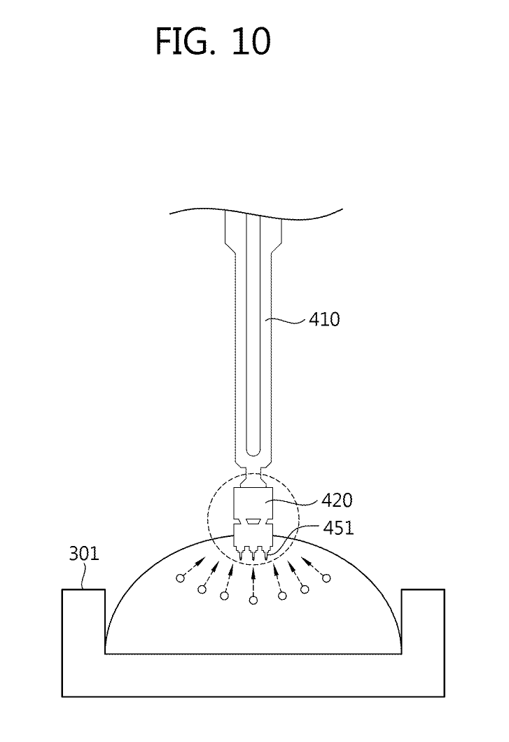

FIG. 10 is a diagram illustrating an extraction process performed by a sample plate and an extraction unit of the particle extraction apparatus of FIG. 1. As shown in FIG. 10, a sample is housed in the sample plate 300, and as the extraction unit 400 moves downward, the micro tip 451 of the extraction unit 400 is disposed to submerge in the sample. The micro tip 451 is electrically connected to the signal generator 700 to form a first electrode, and the sample plate 300 is electrically connected to the signal generator 700 to form a second electrode. Therefore, when an electrical signal (e.g., AC signal) is applied from the signal generator 700, an electrical field is formed within a sample by the first electrode and the second electrode. Thereby, particles are attached to the micro tip 451 to be extracted, and mechanism that extracts particles is disclosed at WO2009/149467 and thus a detailed description thereof will be omitted.

When performing an extraction process using such a particle extraction apparatus, a sample plate and an extraction unit used for preventing pollution are replaced and used with a new one. Therefore, the sample plate and the extraction unit may be provided as consumables. The sample plate may be provided to a user in a form described with reference to FIG. 4. The extraction unit may be provided to the user in an extraction unit assembly form, as described in the following description.

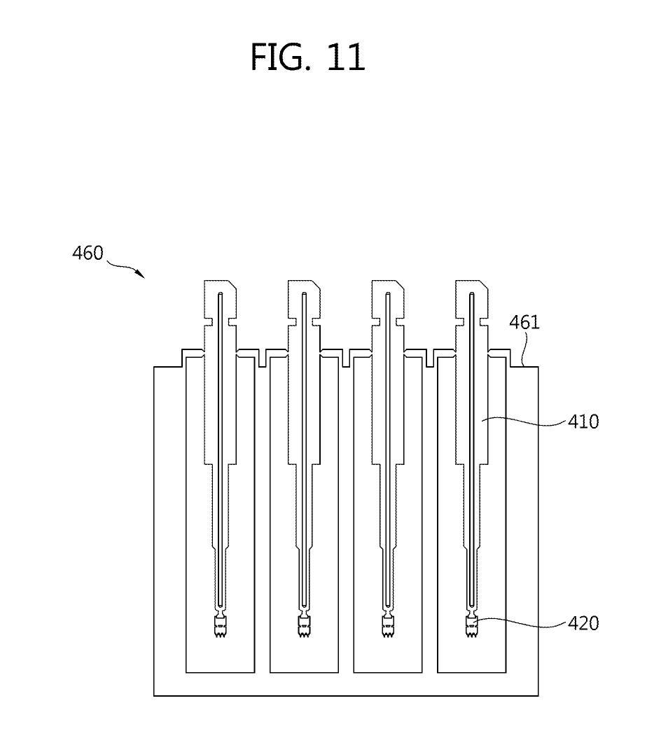

FIG. 11 is a front view illustrating an extraction unit assembly provided as consumables. An extraction unit assembly 460 may include a plurality of extraction units 400 and a guide frame 461. Here, the extraction unit 400 may provide the body 410 and the tip member 420 produced through an individual process in a complete state by soldering. The guide frame 461 is formed in a form that encloses each of a plurality of extraction units 400 and is formed to protect the extraction unit 400, particularly a micro tip. In order to easily separate, a connection portion of the guide frame 461 and the extraction unit 400 may be formed in a V-notch or crack structure. However, such consumables may be provided with other various methods.

The particle extraction apparatus 10 according to the present exemplary embodiment may extract particles through an extraction process and additionally perform a washing process that washes a foreign substance included in the extracted particles. Therefore, before performing a subsequent process such as a test, the particle extraction apparatus 10 can improve purity of a target material extracted through an extraction process.

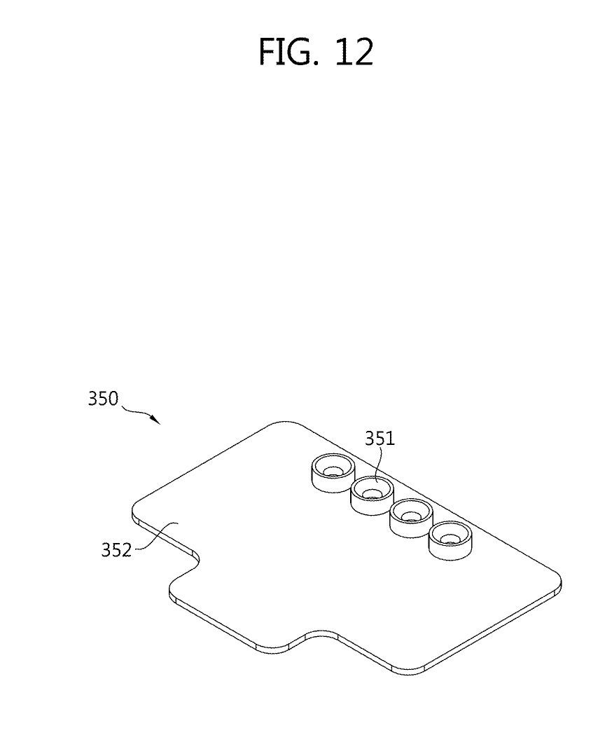

FIG. 12 is a perspective view illustrating a washing plate of the particle extraction apparatus of FIG. 1. The washing plate 350 is formed in a shape corresponding to the foregoing sample plate. Specifically, at one side of the washing plate 350, a plurality of washing wells 351 that house a washing liquid are provided. Each washing well 351 is formed to house a washing reagent or a chemical material of 50-200 uL. At both edges of the washing plate 350 in which the washing well 351 is not formed, an insertion portion is formed. Therefore, in a state in which an insertion portion 352 of the washing plate 350 is inserted into the support unit 200, a washing process may be performed.

Specifically, when an extraction process is terminated, the sample plate 300 is removed from the support unit 200 and the washing plate 350 is installed. In this case, particles are attached to an end portion of the extraction unit 400 through an extraction process. By moving downward an end portion of the extraction unit 400 by driving the driving member 600, the controller 800 controls the end portion to be submerged in a washing liquid of the washing plate 350. While the end portion of the extraction unit 400 is submerged in the washing liquid for a predetermined time, a foreign substance attached to the end portion of the extraction unit 400 is removed. Thereafter, by operating the driving member 600, the controller 800 moves upward an end portion of the extraction unit 400. A foreign substance attached to the end portion of the extraction unit 400 is removed through an extraction process and thus a target material having high purity can be extracted.

In a washing process, unlike the foregoing extraction process, a separate electrical signal is not applied. Therefore, the washing plate may be made of a non-conductive material such as plastic.

In order to perform a washing process, a particle extraction apparatus according to the present exemplary embodiment may provide a washing plate as consumables and may provide a washing reagent as consumables.

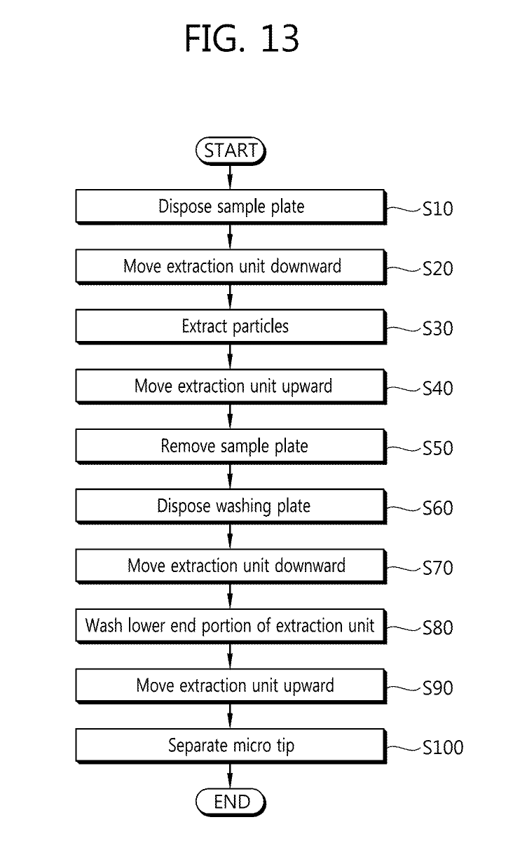

FIG. 13 is a flowchart illustrating a method of extracting particles by operating the particle extraction apparatus of FIG. 1. Hereinafter, a method of controlling a particle extraction apparatus according to the foregoing exemplary embodiment will be described with reference to FIG. 13.

First, the insertion portion 304 of the sample plate 300 is inserted into the support unit 200 and a location thereof is fixed (S10). In this case, the grip portion 220 within the support unit 200 presses and fixes the sample plate 300 using an elastic force of the elastic body 230. Before disposing the sample plate 300, a sample may be in an already housed state in a plurality of samples or in a state in which the sample plate 300 is disposed at the support unit 200, a sample may be housed in a plurality of sample wells using a pipet.

Before or after the sample plate is disposed, a user may separate the extraction unit 400 from the extraction unit assembly 460 and install the extraction unit 400 in the holding member 500. In this case, in a state in which the holding member 500 is separated from the main body 100, the extraction unit 400 is installed in the holding member 500. When installation is complete, the holding member 500 may be again fastened to the lifting member 650 of the main body 100.

For reference, the controller 800 may detect a kind of a plate installed in the support unit 200 and whether a plate is installed using a pressure sensor or an electric sensor. Further, the controller 800 may detect a location of the extraction unit 400 installed in the holding member 500 and whether the holding member 500 is installed. The controller 800 may perform a subsequent process based on detected information or may determine whether abnormality exists.

In this way, when installation of the sample plate 300 and the extraction unit 400 is complete, an extraction process may be performed in a first mode.

First, by operating the driving member 600, the controller 800 moves the extraction unit 400 downward (S20). Specifically, the driving member 600 moves the lifting member 650 of the main body 100 downward, and while the holding member 500 installed in the lifting member 650 moves downward, the extraction unit 400 moves downward in a direction of the sample plate 300. Thereby, the micro tip 451 provided in an end portion of each extraction unit 400 is submerged in a sample of a corresponding sample well 301.

When the micro tip 451 of the extraction unit 400 is submerged in the sample, particles are extracted (S30). Step of extracting particles is performed by forming an electrical field in the sample. Therefore, by driving the signal generator 700, the controller 800 generates an AC signal, and thus an electrical field is formed within the sample. In this case, the micro tip 451 of the extraction unit 400 is electrically connected to the first signal application unit 710 to form a first electrode, and the sample plate 300 is electrically connected to the second signal application unit 720 to form a second electrode. Thereby, by electric-field-induced forces generated within the sample, particles are moved to the micro tip 451, which is a first electrode to be attached to the micro tip 451.

At the foregoing step, when particles are extracted, by operating the driving member 600, the controller 800 moves the extraction unit 400 upward (S40). In this case, as the micro tip 451 of the extraction unit 400 deviates from the sample, particles attached to the micro tip 451 are separated from the sample to be extracted.

As the user inputs an operation mode through the control panel 110, such an extraction process may be performed. An operation time of an extraction process and an output and pattern of an electrical signal may be directly input by the user through a control panel or may be controlled according to a content previously programmed on a memory (internal memory or external memory).

When an extraction process is terminated, the sample plate 300 is removed (S50). Step 50 may be performed by the user, and the sample plate 300 is removed from the support unit 200.

Thereafter, in a second mode, a washing process may be performed. As described above, the washing process is a process of washing the micro tip 451 in which particles are extracted and is performed in a state in which the extraction unit 400 is not replaced.

In order to perform a washing process, the washing plate 350 is disposed (S60). The washing plate 350 is inserted into the support unit 200 in which the sample plate 300 is removed and a location thereof is fixed. A washing liquid may be housed in each washing well 351 of the washing plate 350.

When the washing plate 350 is disposed, by operating the driving member 600, the controller 800 moves the extraction unit 400 downward (S70). Similar to the foregoing step, by operation of the driving member 600, the micro tip 451 of the extraction unit 400 is submerged in a washing liquid of a corresponding washing well 351.

When the above step is terminated, the micro tip 451 is washed (S80). At step S80, the micro tip 451 maintains a state submerged in a washing liquid for a preset time without a separate control. A foreign substance attached to the micro tip 451 is removed through an extraction process of step S80.

When washing is complete by the foregoing step, by operating the driving member 600, the controller 800 moves the extraction unit 400 upward (S90). In this way, by performing a separate washing process after an extraction process, a particle extraction apparatus according to the present exemplary embodiment can acquire a target material of high purity.

As the user inputs an operation mode through the control panel 110, such a washing process may be performed. Contents such as an operation time of a washing process may be specifically input through a control panel by the user or may be controlled according to contents previously programmed on a memory (internal memory or external memory).

In this way, when an extraction process and a washing process are terminated, in order to secure extracted particles, the user separates the micro tip 451 (S100). At step S100, in order to easily separate the micro tip 451, in a state in which each extraction unit 400 is separated from the holding member 500, the micro tip 451 is separated. As an example, in a state in which an end portion of the extraction unit is located within a tube type collection container (e.g., PCR tube), the end portion is pressed. Thereby, a separation portion of the tip member is separated, and by separating only a micro tip to which particles are attached, a subsequent process may be performed.

In this way, as the present invention provides a particle extraction apparatus and a method of extracting particles using the same, even in an environment in addition to a laboratory, particles can be easily and quickly extracted. Further, in one apparatus, because extraction and washing can be continuously performed, a target material having high purity can be secured, and the target material can be prevented from being deteriorated by a foreign substance.

In the foregoing description, the present invention has been described using an exemplary embodiment, but the present invention is not limited to the exemplary embodiment. Those skilled in the art will recognize that the invention can be practiced with modification within the spirit and scope of the appended claims.

What is claimed is:

1. A particle extraction apparatus, comprising:
a main body;
a support unit provided in the main body and in which a sample plate is disposed;
an extraction unit that can be selectively submerged in a sample of the sample plate and that extracts particles within the sample;
a signal generator that generates an electrical signal so as to generate an electrical field within the sample in the sample plate; and
a controller that controls operation of the signal generator,
wherein particles within the sample are attached to the extraction unit by an electrical field generated within the sample to be extracted.

2. The particle extraction apparatus of claim 1, wherein the signal generator applies an electrical signal to the sample plate and the extraction unit so as to generate an electrical field within the sample in a state in which the sample plate is disposed at the support unit.

3. The particle extraction apparatus of claim 1, further comprising a holding member in which the extraction unit is installed and that is formed to move the extraction unit upward and downward in an upper portion of the support unit,
wherein the extraction unit is electrically connected to the signal generator in a state installed in the holding member.

4. The particle extraction apparatus of claim 3, wherein the holding member is configured that a plurality of extraction units are installed, and the plurality of extraction units are respectively connected to the signal generator along an individual path in a state installed in the holding member.

5. The particle extraction apparatus of claim 4, wherein the controller detects a location in which the extraction unit is installed in the holding member and controls the signal generator to apply an electrical signal to a corresponding location.

6. The particle extraction apparatus of claim 1, wherein the extraction unit comprises a body and, a tip member installed in a lower portion of the body and forming a portion in which particles are extracted in a state to be submerged in the sample.

7. The particle extraction apparatus of claim 6, wherein a lower end portion of the tip member comprises at least one micro tip, and the micro tip is formed in a pointed shape having a width of 500 um or less.

8. The particle extraction apparatus of claim 7, wherein in the micro tip, protrusions of 100 um or less are formed along an edge.

9. The particle extraction apparatus of claim 7, wherein the micro tip is formed in a flat shape, and a circumferential edge portion thereof is formed in a sawteeth shape.

10. The particle extraction apparatus of claim 6, wherein the tip member is produced through a separate process from a production process of the body and fixed to a lower end portion of the body.

11. The particle extraction apparatus of claim 10, wherein the tip member is produced through a thin film manufacturing process comprising a deposition process and an etching process.

12. The particle extraction apparatus of claim 11, wherein the tip member comprises a micro tip formed in a relatively small width and small thickness at an end portion and forming a portion to be submerged in the sample, and
the tip member and the micro tip are formed in a flat shape, one surface of the micro tip is formed coplanar to one surface of the tip member, and the other side surface of the micro tip forms a step structure with the other side surface of the tip member.

13. The particle extraction apparatus of claim 10, wherein the tip member comprises a connecting portion fixed to the body and a micro tip portion submerged in the sample, and
the connecting portion and the micro tip portion are connected by a separation portion having relatively weak strength in order to easily separate the micro tip portion in a state in which the connecting portion is fixed to the body.

14. The particle extraction apparatus of claim 13, wherein the separation portion has a cross-sectional area smaller than that of the connecting portion and the micro tip portion.

15. The particle extraction apparatus of claim 11, wherein the tip member is fixed by soldering to a lower end portion of the body.

16. The particle extraction apparatus of claim 1, wherein the support unit is installed to detach the sample plate, and the support unit comprises a grip portion that fixes the sample plate when the sample plate is disposed and a signal application unit that applies an electrical signal to the sample plate in a state in which the sample plate is fixed.

17. The particle extraction apparatus of claim 16, wherein the grip portion comprises an elastic body, and the elastic body is elastically deformed when the sample plate is disposed to provide an elastic force to the sample plate and to fix the sample plate.

18. The particle extraction apparatus of claim 1, wherein the sample plate has a plurality of wells, and a separation wall for preventing pollution from occurring between each well is formed between the each well.

19. The particle extraction apparatus of claim 1, further comprising a washing plate for enhancing purity of particles attached to an end portion of the extraction unit,
wherein the end portion of the extraction unit to which particles are attached is controlled to be submerged in a washing liquid of the washing plate so as to wash a foreign substance, when the washing plate is selectively disposed at the support unit.

20. The particle extraction apparatus of claim 19, wherein the controller controls operation of the signal generator or the extraction unit according to a plurality of modes, and
the plurality of modes comprise a first mode that extracts particles by applying an electrical field in the sample by enabling the extraction unit to be submerged in a sample of the sample plate in a state in which the sample plate is disposed in the support unit and a second mode that washes an extracted materials other than the particle by enabling the extraction unit to be submerged in a washing liquid of the washing plate in a state in which the washing plate is disposed at the support unit.

21. A method of extracting particles, the method comprising:
installing a sample plate containing a sample in a support unit;
moving the extraction unit downward so that a lower end portion of the extraction unit is submerged in a sample of the sample plate;
extracting particles within the sample by applying an electrical signal to the extraction unit and the sample plate;
moving upward the extraction unit to which the particles are attached;
removing the sample plate from the support unit and installing a washing plate that contains a washing liquid in the support unit;
moving the extraction unit downward so as to remove a foreign substance by submerging a lower end portion of the extraction unit in a washing liquid; and
moving the extraction unit upward.

22. An extraction member using in a particle extraction apparatus that extracts particles within a sample by generating an electrical field within the sample, the extraction member comprising:
a body formed in a bar shape and having one end installed in the particle extraction apparatus; and
a tip member attached to the other end portion of the body to form a portion submerged in the sample and having a plurality of micro tips in which protrusions of a sawteeth shape are formed along an edge.
